(19) United States
(12) Patent Application Publication
(10) Pub. No.: US 2026/0088551 A1
(43) Pub. Date: Mar. 26, 2026

(54) CONNECTOR

(71) Applicant: SUMITOMO WIRING SYSTEMS, LTD., Mie (JP)

(72) Inventor: Junya MATSUURA, Mie (JP)

(21) Appl. No.: 19/111,284

(22) PCT Filed: Aug. 31, 2023
(86) PCT No.: PCT/JP2023/031716

§ 371 Date: Mar. 12, 2025

(30) Foreign Application Priority Data
Sep. 21, 2022 (JP) 2022-149933

(51) Int. Cl. H01R 13/424; H01R 12/72

(52) U.S. Cl. CPC H01R 13/424; H01R 12/722

(57) ABSTRACT

A terminal fitting has a terminal connecting part that passes through a through hole in a base wall and a board connecting part that extends downwardly from a rear end portion of the terminal connecting part rearward of the base wall. The through hole in the base wall has a lower inner surface that parallelly opposes a lower surface of the terminal connecting part and an upper inner surface that parallelly opposes an upper surface of the terminal connecting part. The base wall has a lower part that demarcates the lower inner surface and is formed downward of the through hole in a height range of a portion of the base wall that protrudes rearwardly, and an upper part that demarcates the upper inner surface and is formed upward of the through hole in the height range of the portion of the base wall that protrudes rearwardly.

### Technical Field

The present disclosure relates to a connector.

### BACKGROUND

A connector disclosed in Patent Document 1 is provided with a housing that is disposed on the surface of a circuit board and a terminal fitting that is mounted to the housing. The housing has a base wall that extends upwardly from the surface of the circuit board and a tubular peripheral wall that protrudes forwardly from an outer edge of the base wall. A through hole is formed in the base wall. The terminal fitting has a terminal connecting part that is pin-shaped, passes through the through hole in the base wall, and is connected to a partner terminal fitting on the inner side of the peripheral wall, and a board connecting part that is connected to the circuit board by soldering at a lower end portion that is rearward of the board. The terminal connecting part (swingably supported part) of the terminal fitting (contact terminal) is swingably supported by the base wall in a state of passing through the through hole (mounting hole) and slopes in a range of a gap formed with a rearwardly protruding portion (terminal supporting plate) of the base wall. Note that board connectors are also disclosed in Patent Documents 2 to 4.

### Prior Art Document

### Patent Document

Patent Document 1: JP 2011-187213 A
Patent Document 2: JP 2019-204744 A
Patent Document 3: JP 2005-190680 A
Patent Document 4: JP 2005-116230 A

### SUMMARY OF THE INVENTION

### Problems to be Solved

There is concern that, when the board connecting part is connected to the surface of the circuit board with reflow solder, for example, the housing will thermally expand. When the housing thermally expands, the position at which the terminal connecting part passes through the through hole in the base wall may be displaced upwardly, and the board connecting part may lift away from the surface of the circuit board.

In view of this, an object of the present disclosure is to provide a connector capable of preventing a terminal fitting from lifting away from a circuit board.

### Means to Solve the Problem

A connector of the present disclosure includes a housing to be disposed on a surface of a circuit board and a terminal fitting mounted to the housing, the housing including a base wall having a shape extending upwardly from the surface of the circuit board and a tubular peripheral wall protruding forwardly from an outer edge of the base wall, the terminal fitting including a terminal connecting part passing through a through hole in the base wall and to be connected to a partner terminal fitting on an inner side of the peripheral wall, and a board connecting part extending downwardly from a rear end portion of the terminal connecting part rearward of the base wall and to be connected at a lower end portion to the surface of the circuit board by soldering, the through hole including a lower inner surface parallelly opposing a lower surface of the terminal connecting part and an upper inner surface parallelly opposing an upper surface of the terminal connecting part, the base wall including a lower part demarcating the lower inner surface and formed downward of the through hole in a height range of a portion of the base wall protruding rearwardly and an upper part demarcating the upper inner surface and formed upward of the through hole in the height range of the portion of the base wall protruding rearwardly, and the upper part having a larger volume than the lower part.

### Effect of the Invention

According to the present disclosure, a connector capable of preventing a terminal fitting from lifting away from a circuit board can be provided.

### BRIEF DESCRIPTION OF THE DRAWINGS

FIG. 1 is a cross-sectional view of a connector mated to a partner housing in a first embodiment of the present disclosure.

FIG. 2 is a perspective view of the connector.

FIG. 3 is a partially enlarged rear view of the connector.

FIG. 4 is a cross-sectional view along line A-A in FIG. 3.

FIG. 5 is a cross-sectional view along line B-B in FIG. 3.

FIG. 6 is a partially enlarged cross-sectional view of FIG. 5.

### DETAILED DESCRIPTION TO EXECUTE THE INVENTION

### Description of Embodiments of Disclosure

Initially, modes of the present disclosure will be enumerated and described.
(1) A connector of the present disclosure is a connector including a housing to be disposed on a surface of a circuit board and a terminal fitting mounted to the housing, in which the housing includes a base wall having a shape extending upwardly from the surface of the circuit board and a tubular peripheral wall protruding forwardly from an outer edge of the base wall, the terminal fitting includes a terminal connecting part passing through a through hole in the base wall and to be connected to a partner terminal fitting on an inner side of the peripheral wall, and a board connecting part extending downwardly from a rear end portion of the terminal connecting part rearward of the base wall and to be connected at a lower end portion to the surface of the circuit board by soldering, the through hole includes a lower inner surface parallelly opposing a lower surface of the terminal connecting part and an upper inner surface parallelly opposing an upper surface of the terminal connecting part, the base wall includes a lower part demarcating the lower inner surface and formed downward of the through hole in a height range of a portion of the base wall protruding rearwardly and an upper part demarcating the upper inner surface and formed upward of the through hole in the height range of the portion of the base wall protruding rearwardly, and the upper part has a larger volume than the lower part.

According to the above configuration, the upper part has a larger volume than the lower part, thus enabling thermal expansion of the upper part to be reduced to less than thermal expansion of the lower part in the up-down direction. Therefore, thermal expansion of the upper part due to heating during mounting of the connector or the like can be suppressed. As a result, upward displacement of the position at which the terminal connecting part passes through the through hole in the base wall can be suppressed, and the board connecting part can be prevented from lifting away from the circuit board.
(2) Preferably the upper inner surface of the upper part is formed longer than the lower inner surface of the lower part in a front-back direction, and a rear end of the upper inner surface of the upper part is located rearward of a rear end of the lower inner surface of the lower part.

According to the above configuration, the terminal connecting part is able to come in contact with a long portion of the upper inner surface of the upper part, and displacement of the rear end side of the terminal connecting part so as to tilt upwardly on the inner side of the through hole can be suppressed. As a result, the board connecting part can be effectively prevented from lifting away from the circuit board.
(3) Preferably the upper part is formed thicker than the lower part in an up-down direction.

According to the above configuration, contact pressure on the terminal connecting part from the upper part side can be increased, and thus the board connecting part can be prevented from lifting away from the circuit board, without making the upper inner surface of the upper part especially long in the front-back direction.
(4) Preferably the upper part has an upper-side guiding surface sloping upward rearwardly from the rear end of the upper inner surface, the lower part has a lower-side guiding surface sloping downward rearwardly from the rear end of the lower inner surface, and a front end of the lower-side guiding surface is located forward of a front end of the upper-side guiding surface.

According to the above configuration, the upper-side guiding surface and the lower-side guiding surface are able to perform the function of guiding the terminal connecting part into the through hole. In particular, the front end of the lower-side guiding surface is located forward of the front end of the upper-side guiding surface and is continuous with the rear end of the lower inner surface of the lower part, thus enabling the shape whereby the lower inner surface of the lower part is shorter than the upper inner surface of the upper part in the front-back direction to be efficiently formed.

### DETAILED DESCRIPTION OF EMBODIMENTS OF DISCLOSURE

Specific examples of the present disclosure will be described below with reference to the drawings. Note that the present invention is not limited to these illustrative examples and is indicated by the claims, and all changes that come within the meaning and range of equivalency of the claims are intended to be embraced therein.

### First Embodiment

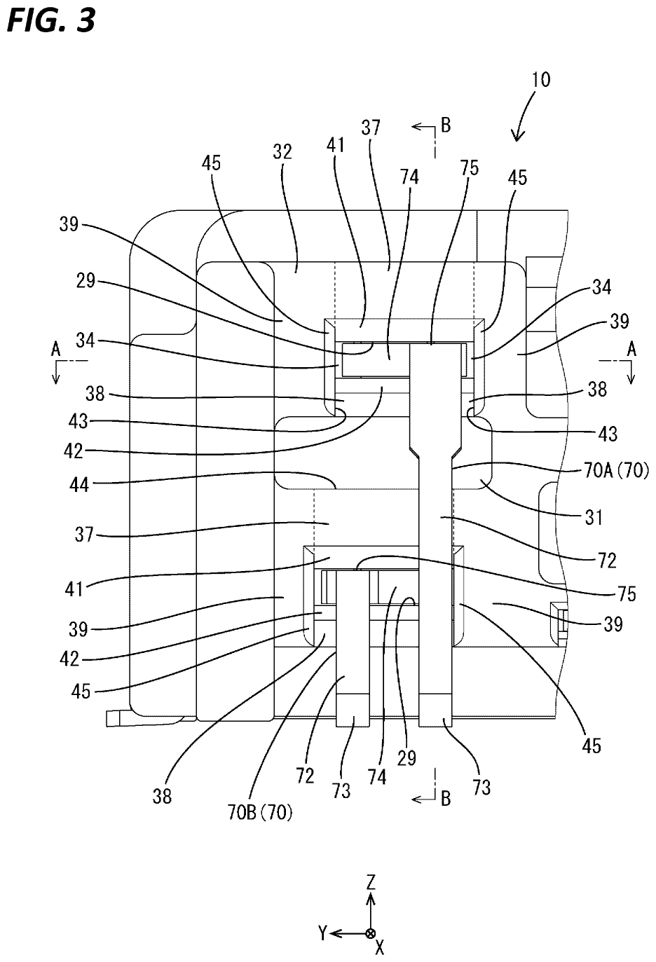

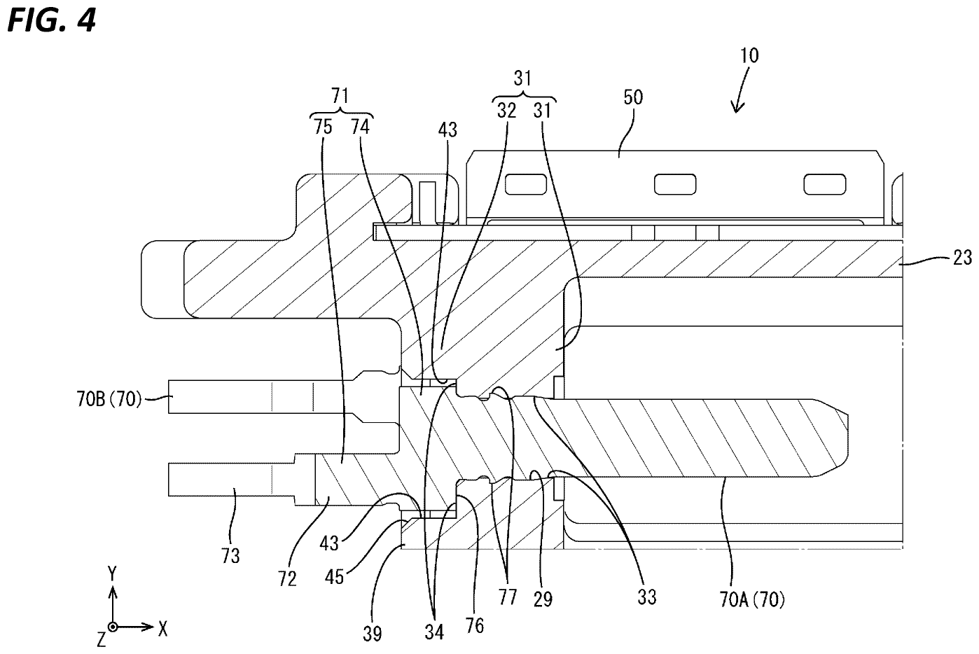

A connector 10 according to a first embodiment of the present disclosure is a board connector and is provided with a housing 20 that is disposed on the surface of a circuit board 90 and a terminal fitting 70 that is attached to the housing 20. The housing 20 is mated to a partner housing 60. Note that, in the following description, the side on which the housing 20 is mated to the partner housing 60 is the front side in the front-back direction. The right side in each diagram except FIG. 3 is the front side (reference numeral X). The housing 20 is installed on the surface of the circuit board 90 from the upper side in the up-down direction. The upper side in each diagram except FIG. 4 is the upper side (reference numeral Z). The up-down direction is synonymous with a height direction. The left-right direction is based on the left-right direction as viewed from the front side, and the left side in FIG. 3, which is a rear view, is the right side (reference numeral Y). The left-right direction is synonymous with a width direction. These directions are for the sake of convenience and do not necessarily coincide with the directions in a state where the connector 10 is installed in a vehicle or the like not shown.

### Partner Housing

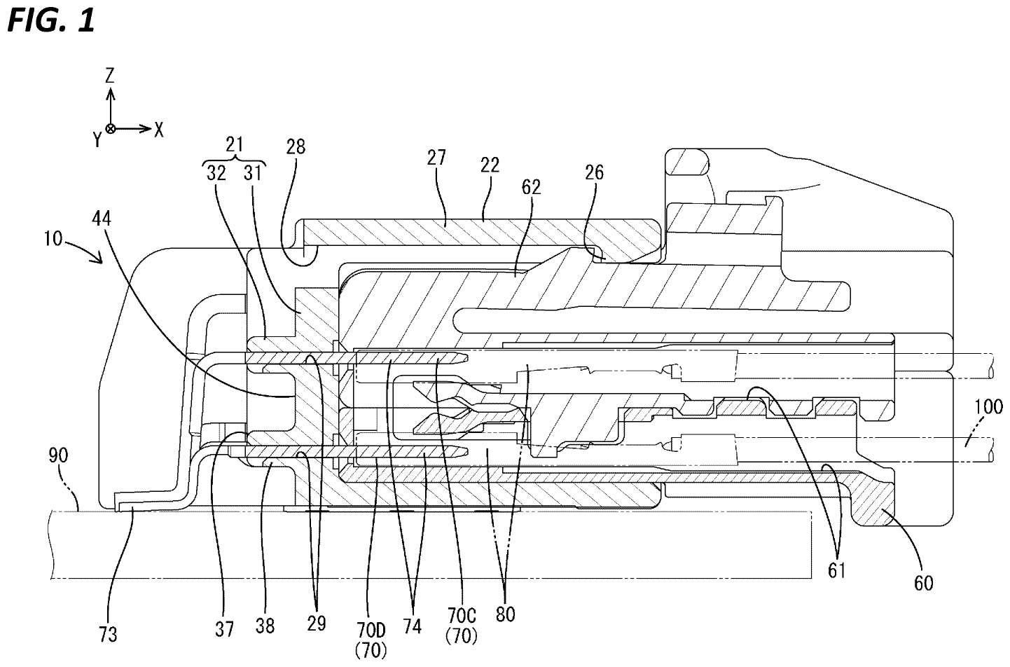

The partner housing 60 is made of synthetic resin and, as shown in FIG. 1, is constituted as a square block-shaped female housing. The partner housing 60 has a plurality of cavities 61. Each cavity 61 houses a partner terminal fitting 80 serving as a female terminal fitting connected to a terminal part of an electrical wire 100. The partner housing 60 has a locking arm 62 that holds the housing 20 and the partner housing 60 in a mated state.

### Housing and Terminal Fittings

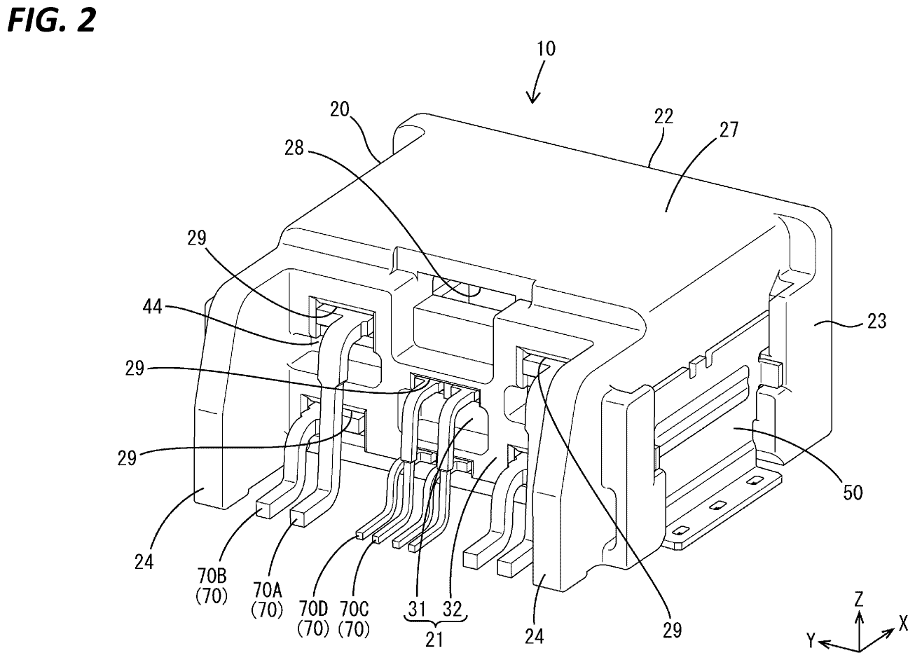

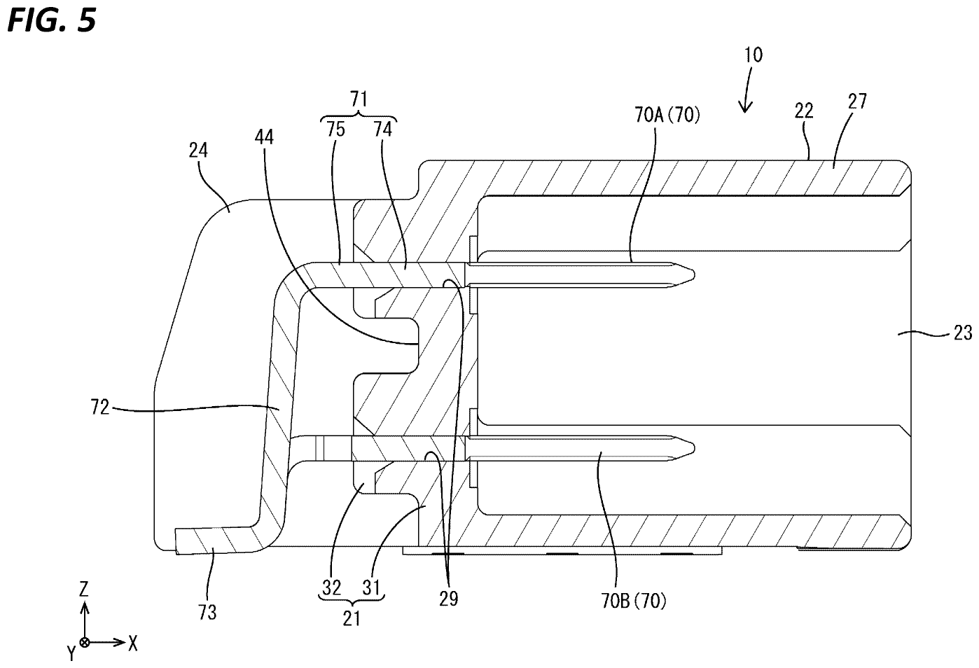

The housing 20 is made of synthetic resin and is hood shaped as a whole. As shown in FIGS. 2 and 5, the housing 20 has a base wall 21 that has a rectangular shape in rear view and extends upwardly in the up-down direction and a square-tubular shaped peripheral wall 22 that protrudes forwardly from an outer edge of the base wall 21. Sidewall parts 23 on both left and right sides of the peripheral wall 22 each have a protective wall part 24 that protrudes rearwardly of the base wall 21. The protective wall part 24 protects a later-described board connecting part 72 of the terminal fitting 70 from the side. As shown in FIG. 2, a fixing member 50 is mounted to an outer surface of each sidewall part 23. The fixing member 50 is a metal plate and is, in a state of being mounted to the housing 20, fixed to the surface of the circuit board 90 by soldering.

As shown in FIG. 1, a locking part 26 is formed on the center side of an upper wall part 27 of the peripheral wall 22 in the left-right direction. The locking part 26 protrudes on the inner side of the peripheral wall 22. The locking part 26 is locked by a locking arm 62 of the partner housing 60. On the upper end side of the base wall 21 is formed an extraction hole 28 resulting from extraction of a mold (not shown) for molding the locking part 26.

As shown in FIGS. 1 and 5, a plurality of through holes 29 are formed in the base wall 21. The through holes 29 each have a rectangular opening shape that is long in the left-right direction and, as shown in FIG. 2, are arranged on two levels, upper and lower, and in a plurality of rows in the width direction. Two rows of through holes 29 disposed on the center side in the left-right direction are disposed downward of the extraction hole 28 with an opening diameter smaller than the through holes 29 disposed on both sides in the left-right direction.

The terminal fitting 70 is tab-shaped and made of a conductive metal and is held by the base wall 21 in a state of passing through each through hole 29. As shown in FIG. 2, the terminal fitting 70 of the first embodiment is constituted by four types: a large, long terminal fitting 70A that passes through the through hole 29 disposed on the upper level on both sides in the left-right direction, a large, short terminal fitting 70B that passes through the through hole 29 disposed on the lower level on both sides in the left-right direction, a small, long terminal fitting 70C that passes through the through hole 29 disposed on the upper level on the center side in the left-right direction, and a small, short terminal fitting 70D that passes through the through hole 29 disposed on the lower level on the center side in the left-right direction. Note that, in the following description, the terminal fittings 70A, 70B, 70C, and 70D will be collectively referred to as the terminal fittings 70, unless it is particularly necessary to distinguish therebetween.

The terminal fittings 70 are tab shaped, and, as shown in FIG. 5, each have a terminal connecting part 71 that passes through the through hole 29 and extends in the front-back direction, and a board connecting part 72 that extends downwardly from a rear end portion of the terminal connecting part 71 rearward of the base wall 21. The board connecting part 72 has a solder connecting part 73 that bends and extends rearwardly from the lower end side. The solder connecting part 73 is electrically connected by soldering to a conductive part (not shown) formed on the surface of the circuit board 90 (see FIG. 1).

As shown in FIG. 4, the terminal connecting part 71 has a connection body part 74 that is disposed on the inner side of the through hole 29 and the inner side of the peripheral wall 22, and a joining part 75 that has a plate width (dimension in left-right direction) smaller than the connection body part 74 and is lead out of the through hole 29. At the time of the mating the housing 20 to the partner housing 60, the connection body part 74 is electrically connected to the partner terminal fitting 80 mounted to the partner housing 60 on the inner side of the peripheral wall 22, as shown in FIG. 1.

As shown in FIG. 3, in the long terminal fittings 70A and 70C disposed on the upper level (only 70A is shown in FIG. 3), the joining part 75 is coupled to one side (right side in FIG. 3) of the rear end face of the connection body part 74 in the left-right direction. In the short terminal fittings 70B and 70D disposed on the lower level (only 70B shown in FIG. 3), the joining part 75 is coupled to the other side (left side in FIG. 3) of the rear end face of the connection body part 74 in the left-right direction. The two levels of upper and lower terminal fittings 70 thereby avoid interfering with each other.

As shown in FIG. 4, the rear end portion of the connection body part 74 has a stepped surface 76 that faces forward, at a position on the opposite side to the rear end face to which the joining part 75 is coupled. When the connection body part 74 is inserted into the through hole 29 from the rear, the stepped surface 76 hits left and right opening end faces 34 of the through hole 29 on the rear surface of a base wall body part 31 described later, and the insertion movement of the terminal fitting 70 is stopped. Also, the rear end portion of the connection body part 74 has a locking protrusion 77 that protrudes on both left and right sides at a position forward of the stepped surface 76. As a result of the stepped surface 76 hitting the left and right opening end faces 34 of the through hole 29 and the locking protrusions 77 being locked so as to dig into left and right surfaces 33 on the inner side of the through hole 29, the terminal fitting 70 is inserted into the through hole 29 and held by the base wall 21.

As shown in FIGS. 1 and 5, the base wall 21 has the base wall body part 31 disposed spanning the entire height of the housing 20 in the up-down direction, and a protruding part 32 (portion of base wall 21 protruding rearwardly) that protrude rearwardly from the rear surface of the base wall body part 31. The base wall body part 31 has a rectangular plate shape in rear view and has an outer edge continuous with the peripheral wall 22. The base wall 21 is thickly formed in the front-back direction in a height range of the protruding part 32.

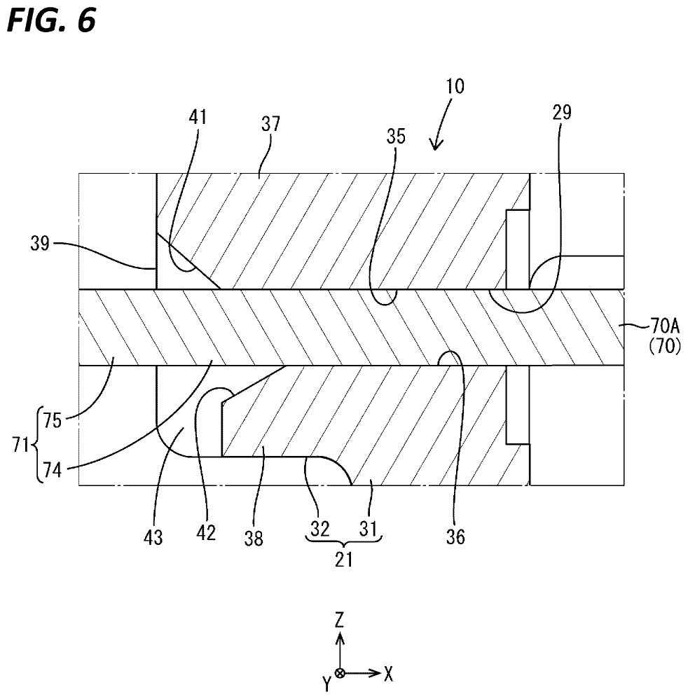

As shown in FIG. 4, the left and right surfaces 33 on the inner side of the through hole 29 are formed only in the base wall body part 31 and intersect the opening end faces 34 at the rear end. As shown in FIG. 6, an upper inner surface 35 (surface facing lower side) and a lower inner surface 36 (surface facing upper side) of the through hole 29 are disposed horizontally so as to extend in the front-back direction from the base wall body part 31 to the protruding part 32. The upper surface of the connection body part 74 of the terminal connecting part 71 is disposed so as to parallelly oppose the upper inner surface 35 of the through hole 29 in contact therewith. The lower surface of the connection body part 74 of the terminal connecting part 71 is disposed so as to parallelly oppose the lower inner surface 36 of the through hole 29 in contact therewith.

As shown in FIG. 3, the protruding part 32 has an upper part 37, a lower part 38, and a side part 39, at the opening edge portion of the through hole 29 in the rear surface of the base wall body part 31.

The upper part 37 has a square block shape that is long in the left-right direction, and, as shown in FIG. 6, is located upward of the through hole 29 and demarcates the upper inner surface 35. The upper inner surface 35 corresponds to the lower surface of the upper part 37. The upper surface of the upper part 37 is the upper surface of the protruding part 32 and is disposed horizontally in the front-back direction. The rear surface of the upper part 37 is disposed so as to rise up in the up-down direction. The upper part 37 has an upper-side guiding surface 41 that slopes upwardly from the rear end of the upper inner surface 35 to the rear surface of the upper part 37.

The lower part 38 has a square block shape that is long in the left-right direction, and, as shown in FIG. 6, is located downward of the through hole 29 and demarcates the lower inner surface 36. The lower inner surface 36 corresponds to the upper surface of the lower part 38. The up-down thickness (dimension in up-down direction) of the lower part 38 is made thinner than the up-down thickness of the upper part 37. The front-back length (dimension in front-back direction) of the lower part 38 is made shorter than the front-back length of the upper part 37. Also, the front-back length of the lower inner surface 36 is made shorter than the front-back length of the upper inner surface 35. The volume (resin amount) of the lower part 38 is made smaller than the volume of the upper part 37 as a whole.

The lower surface of the lower part 38 is the lower surface of the protruding part 32 and is disposed horizontally in the front-back direction at a position on the opposite side to the upper surface of the upper part 37. The rear surface of the lower part 38 is disposed so as to rise up in the up-down direction at a deeper position forward of the rear surface of the upper part 37 (see FIGS. 3 and 6). The lower part 38 has a lower-side guiding surface 42 that slopes downward from the rear end of the lower inner surface 36 of the through hole 29 to the rear surface of the lower part 38. As shown in FIG. 6, the front-back length of the lower-side guiding surface 42 is made the same as the front-back length of the upper-side guiding surface 41. Given that the rear end of the lower inner surface 36 is located forward of the rear end of the upper inner surface 35, the lower-side guiding surface 42 is displaced (shifted) forward of the upper-side guiding surface 41 as a whole.

As shown in FIG. 3, the side part 39 has a square block shape that is long in the up-down direction and is disposed as a pair on both left and right sides across the through hole 29. The side parts 39 have opposing surfaces 43 that extend in the front-back direction and intersect and are continuous with the left and right opening end faces 34 of the through hole 29 at the front end (see FIG. 4). The rear surface of each side part 39 is disposed so as to rise up in the up-down direction. The rear surface of the side parts 39 is steplessly continuous with the rear surface of the upper part 37 rearward of the rear surface of the lower part 38 (dotted line in FIG. 3 is the boundary between side part 39 and upper part 37). The side parts 39 have lateral guiding surfaces 45 that open out on both left and right sides from the rear end of the opposing surfaces to the rear surfaces of the side parts 39. The lateral guiding surfaces 45 are formed with a short front-back length forward of the upper-side guiding surface 41 and the lower-side guiding surface 42. Note that, as shown in FIGS. 1 to 3, a recess 44 is demarcated, on the rear surface of the base wall 21, between the lower part 38 on the upper level, the upper part 37 of the lower level, and the rear surface of the base wall body part 31.

### Operation of Connector

At the time of assembly, the terminal fittings 70 are inserted into the through holes 29 in the base wall 21 from the rear. The terminal connecting part 71 of each terminal fitting 70 is guided into the through hole 29 by the lateral guiding surfaces 45, the upper-side guiding surface 41, and the lower-side guiding surface 42.

Here, as shown in FIG. 6, the front-back length where the upper surface of the connection body part 74 contacts the upper inner surface 35 is made longer than the front-back length where the lower surface of the connection body part 74 contacts the lower inner surface 36. The larger volume upper part 37 that is thicker in the up-down direction is disposed upward of the rear end side of the connection body part 74, and the lower volume lower part 38 that is thinner in the up-down direction compared with the upper part 37 is disposed downward of the rear end side of the connection body part 74.

After assembly of the terminal fittings 70, the connector 10 is placed on the surface of the circuit board 90 and transitioned to a reflow process. The solder connecting part 73 of each terminal fitting 70 is connected by soldering to a conductive portion (not shown) of the circuit board 90 through the reflow process. There is concern that the housing 20 will thermally expand on the surface of the circuit board 90 when the connector 10 is heated inside a reflow oven (not shown). Hypothetically, when the housing 20 thermally expands, the solder connecting parts 73 of the terminal fittings 70 could possibly lift away from the surface of the circuit board 90, resulting in mounting failure.

However, in the case of the first embodiment, the larger volume upper part 37 described above is disposed so as to cover the rear end side of the connection body parts 74 of the terminal fittings 70 from above. Thermal expansion of the upper part 37 in the up-down direction is thus suppressed, and the upper part 37 is less likely to thermally expand. As a result, upward displacement of the upper inner surface 35 of the through hole 29 is suppressed, enabling the state in which the connection body part 74 of the terminal fitting 70 is horizontally disposed along the upper inner surface 35 to be maintained. As a result of the horizontal state of the connection body part 74 being maintained, the solder connecting part 73 can be prevented from lifting away from the surface of the circuit board 90. Also, by preventing the solder connecting part 73 of the terminal fitting 70 from lifting away from the surface of the circuit board 90, the height position of the solder connecting part 73 can be aligned with a fixed position, and coplanarity can be stabilized.

As described above, according to the first embodiment, the larger volume upper part 37 is able to suppress upward displacement of the connection body part 74, thus enabling the solder connecting part 73 to be prevented from lifting away from the circuit board 90.

Also, the front-back length of the upper inner surface 35 of the upper part 37 is formed longer than the front-back length of the lower inner surface 36 of the lower part 38, and the rear end of the upper inner surface 35 is located rearward of the rear end of the lower inner surface 36, thus enabling the terminal connecting part 71 to come in contact with a long portion of the upper inner surface 35 of the upper part 37, and enabling upward displacement of the rear end side of the terminal connecting part 71 on the inner side of the through hole to be suppressed. As a result, the board connecting part 72 can be effectively prevented from lifting away from the circuit board 90.

Also, the up-down thickness of the upper part 37 is formed thicker than the up-down thickness of the lower part 38, and thus contact pressure on the terminal connecting part 71 from the upper part 37 side can be increased. As a result, the board connecting part 72 can be prevented from lifting away from the circuit board 90, without making the upper inner surface 35 of the upper part 37 especially long in the front-back direction.

Furthermore, according to the first embodiment, the upper part 37 has the upper-side guiding surface 41 that slopes upward toward the rear from the rear end of the upper inner surface 35, and the lower part 38 has the lower-side guiding surface 42 that slopes downward toward the rear from the rear end of the lower inner surface 36, and the front end of the lower-side guiding surface 42 is located forward of the front end of the upper-side guiding surface 41. Thus, in addition to being able to properly exhibit the function of guiding the terminal connecting part 71, the shape whereby the front-back length of the lower inner surface 36 of the lower part 38 is shorter than the front-back length of the upper inner surface 35 of the upper part 37 can be efficiently formed without redundancy.

### Other Embodiments of Disclosure

The embodiments disclosed herein are to be considered in all respects as exemplary and not restrictive.

In the case of the first embodiment, the front-back length of the upper inner surface of the upper part is formed longer than the front-back length of the lower inner surface of the lower part, and the up-down thickness of the upper part is formed thicker than the up-down thickness of the lower part. Alternatively, according to another embodiment, the up-down thickness of the upper part may be formed the same as or thinner than the up-down thickness of the lower part, while the front-back length of the upper inner surface of the upper part is formed longer than the front-back length of the lower inner surface of the lower part. Also, according to another embodiment, the front-back length of the upper inner surface of the upper part may be formed the same as or shorter than the front-back length of the lower inner surface of the lower part, while the up-down thickness of the upper part is formed thicker than the up-down thickness of the lower part.

In the case of the first embodiment, the two (upper and lower) levels of upper parts are formed to have the same volume as each other. Alternatively, according to another embodiment, a configuration may be adopted in which the upper parts are formed such that the volume of the upper-level upper part is larger than the volume of the lower-level upper part, and settings are strictly configured corresponding to the coefficient of thermal expansion of the housing.

### List of Reference Numerals

10 Connector
20 Housing
21 Base wall
22 Peripheral wall
23 Sidewall part
24 Protective wall part
26 Locking part
27 Upper wall part
28 Through hole
29 Extraction hole
31 Base wall body part
32 Protruding part (portion of base wall protruding rearwardly)
33 Left and right surfaces
34 Opening end face
35 Upper inner surface
36 Lower inner surface
37 Upper part
38 Lower part
39 Side part
41 Upper guiding surface
42 Lower guiding surface
43 Opposing surface
44 Recess
45 Lateral guiding surface
50 Fixing member
60 Partner housing
61 Cavity
62 Locking arm
70 Terminal fitting
70A Large, long terminal fitting
70B Large, short terminal fitting
70C Small, long terminal fitting
70D Small, short terminal fitting
71 Terminal connecting part
72 Board connecting part
73 Solder connecting part
74 Connection body part
75 Joining part
76 Stepped surface
77 Locking protrusion
80 Partner terminal fitting
90 Circuit board
100 Electrical wire

1. A connector comprising:
a housing to be disposed on a surface of a circuit board; and
a terminal fitting mounted to the housing,
wherein the housing includes:
a base wall having a shape extending upwardly from the surface of the circuit board; and
a tubular peripheral wall protruding forwardly from an outer edge of the base wall,
the terminal fitting includes:
a terminal connecting part passing through a through hole in the base wall and to be connected to a partner terminal fitting on an inner side of the peripheral wall; and
a board connecting part extending downwardly from a rear end portion of the terminal connecting part rearward of the base wall, and to be connected at a lower end portion to the surface of the circuit board by soldering,
the through hole includes:
a lower inner surface parallelly opposing a lower surface of the terminal connecting part; and
an upper inner surface parallelly opposing an upper surface of the terminal connecting part,
the base wall includes:
a lower part demarcating the lower inner surface and formed downward of the through hole in a height range of a portion of the base wall protruding rearwardly; and
an upper part demarcating the upper inner surface and formed upward of the through hole in the height range of the portion of the base wall protruding rearwardly,
the upper part has a larger volume than the lower part,
an upper surface of the upper part and a lower surface of the lower part are both horizontally disposed in the front-back direction, and
a thickness in an up-down direction defined between the upper surface of the upper part and the upper inner surface is thicker than a thickness in the up-down direction defined between the lower surface of the lower part and the lower inner surface.

2. The connector according to claim 1,
wherein the upper inner surface of the upper part is formed longer than the lower inner surface of the lower part in a front-back direction, and
a rear end of the upper inner surface of the upper part is located rearward of a rear end of the lower inner surface of the lower part.

3. The connector according to claim 2,
wherein the base wall includes:
a base wall body part formed spanning an entire height of the housing in the up-down direction; and
a protruding part protruding rearward from a rear surface of the base wall body part,
the protruding part includes, on an opening edge portion of the through hole, the upper part, a side part laterally continuous with the upper part and extending in the up-down direction, and the lower part, and
the upper surface of the upper part is an upper surface of the protruding part, and the lower surface of the lower part is a lower surface of the protruding part.

4. The connector according to claim 2,
wherein the upper part has an upper-side guiding surface sloping upward rearwardly from the rear end of the upper inner surface,
the lower part has a lower-side guiding surface sloping downward rearwardly from the rear end of the lower inner surface, and
a front end of the lower-side guiding surface is located forward of a front end of the upper-side guiding surface.
